(19) United States
(12) Patent Application Publication
(10) Pub. No.: US 2025/0323272 A1
(43) Pub. Date: Oct. 16, 2025

(54) NEGATIVE ELECTRODE ACTIVE MATERIALS, METHOD OF PREPARING SAME, AND RECHARGEABLE LITHIUM BATTERIES INCLUDING SAME

(71) Applicant: Samsung SDI Co., Ltd., Yongin-si (KR)

(72) Inventors: Eunjoo LEE, Yongin-si (KR); Chul YOUM, Yongin-si (KR)

(21) Appl. No.: 19/175,815

(22) Filed: Apr. 10, 2025

(30) Foreign Application Priority Data
Apr. 11, 2024 (KR) 10-2024-0048824

(51) Int. Cl. H01M 4/62; H01M 4/02; H01M 4/04; H01M 4/134; H01M 4/38

(52) U.S. Cl. CPC H01M 4/625; H01M 4/0471; H01M 4/134; H01M 4/386; H01M 2004/021; H01M 2004/027

(57) ABSTRACT

A negative electrode active material, a method of preparing the same, and rechargeable lithium battery including the same are disclosed, where the negative electrode active material includes a crystalline carbon matrix having a BET specific surface area of less than or equal to about 8 m²/g and a graphitization degree of greater than or equal to about 95%, and silicon dispersed in the crystalline carbon matrix.

### CROSS-REFERENCE TO RELATED APPLICATION

The present application claims priority to and the benefit of Korean Patent Application No. 10-2024-0048824, filed on Apr. 11, 2024, in the Korean Intellectual Property Office, the entire disclosure of which is incorporated herein by reference.

### BACKGROUND

### 1. Field

One or more aspects of embodiments of the present disclosure are directed toward negative electrode active materials, methods of preparing the negative electrode active materials, and rechargeable lithium batteries including the negative electrode active materials.

### 2. Description of the Related Art

Recently, the rapid spread of electronic devices that use batteries (such as mobile phones and/or laptop computers), along with rapid growth of electric vehicles, has significantly increased the demand for rechargeable batteries with relatively high energy density and high capacity. Accordingly, there is active research and development aimed at enhancing (improving) the performance of rechargeable batteries, especially rechargeable lithium batteries.

Rechargeable lithium batteries include (are composed of) a positive electrode and a negative electrode, both including active materials capable of intercalating and deintercalating lithium ions, along with an electrolyte. These rechargeable lithium batteries generate electrical energy through oxidation and reduction reactions as lithium ions are intercalated and deintercalated into and from the positive electrode and the negative electrode.

### SUMMARY

One or more aspects of the present embodiments provide a negative electrode active material that exhibits excellent or improved capacity and high or improved input/output characteristics.

One or more aspects of the present embodiments provide a method for preparing the negative electrode active material.

One or more aspects of the present embodiments provide a rechargeable lithium battery including the negative electrode active material.

Additional aspects will be set forth in part in the description which follows and, in part, will be apparent from the description, or may be learned by practice of the presented embodiments of the disclosure.

One or more embodiments provide a negative electrode active material that includes a crystalline carbon matrix having a BET (Brunauer-Emmett-Teller) specific surface area of less than or equal to about 8 m²/g and a graphitization degree of greater than or equal to about 95%; and silicon dispersed in the crystalline carbon matrix.

One or more embodiments provide a method of preparing a negative electrode active material that includes mixing a hard carbon precursor and a metal catalyst to prepare a mixture; heat-treating the mixture to produce a heat-treated product; removing the metal catalyst from the heat-treated product to produce a crystalline carbon matrix; and supporting silicon on the crystalline carbon matrix (e.g., dispersing silicon in the crystalline carbon matrix).

One or more embodiments provide a rechargeable lithium battery including a negative electrode including the negative electrode active material; a positive electrode; and a non-aqueous electrolyte.

The negative electrode active material according to some example embodiments may exhibit excellent or improved cycle-life and high or improved input/output characteristics.

### BRIEF DESCRIPTION OF THE DRAWINGS

FIG. 1 is a diagram schematically showing a negative electrode active material according to one or more embodiments.

FIG. 2 is a diagram showing a method of preparing a negative electrode active material according to one or more embodiments.

FIGS. 3-6 are cross-sectional views each schematically showing a rechargeable lithium battery according to one or more embodiments.

### DETAILED DESCRIPTION

Hereinafter, embodiments will be described in more detail. However, these embodiments are presented as an example, and the present disclosure is not limited thereto, and the present disclosure is defined by the scope of the claims described in more detail herein below.

As used herein, if (e.g., when) specific definition is not otherwise provided, it will be understood that if (e.g., when) an element such as a layer, film, region, and/or substrate is referred to as being “on” another element, it may be directly on the other element (e.g., without any intervening elements therebetween) or one or more intervening elements may also be present. In contrast, if (e.g., when) an element is referred to as being “directly on” another element, there are no intervening elements present. I

As used herein, if (e.g., when) specific definition is not otherwise provided, the singular may also include the plural. In addition, unless otherwise specified, “A or B” may refer to “including A, including B, or including A and B.” In the disclosure, the singular forms “a,” “an,” and “the” are intended to include the plural forms as well, unless the context clearly indicates otherwise. Further, the utilization of “may” when describing embodiments of the present disclosure refers to “one or more embodiments of the present disclosure”.

As used herein, “combination thereof” may refer to a mixture, a stack, a composite, a copolymer, an alloy, a blend, and/or a reaction product of constituents.

As used herein, if (e.g., when) a definition is not otherwise provided, the particle diameter may be an average particle diameter. This average particle diameter refers to the average particle diameter (D50), which refers to a diameter (D50) of particles having a cumulative volume of 50 volume % in a particle size distribution. The average particle diameter may be measured by any suitable method in the art, for example, may be measured by a particle size analyzer, or may be measured by a transmission electron microscope (TEM) image or a scanning electron microscope (SEM) image. In one or more embodiments, it is possible to obtain an average particle diameter value by measuring it using a dynamic light-scattering method, performing data analysis, counting the number of particles for each particle size range, and calculating from this. A laser diffraction method may also be utilized. If measuring by laser diffraction, more specifically, the particles to be measured are dispersed in a dispersion medium and then introduced into a commercially available laser diffraction particle size measuring device (e.g., MT-3000™ available from Micro-Trak Systems, Inc.) using ultrasonic waves at about 28 kHz, and after irradiation with an output of 60 W, the average particle size (D50) based on 50% of the particle size distribution in the measuring device may be calculated.

In the present specification, when particles are spherical, “diameter” indicates a particle diameter, and when the particles are non-spherical, the “diameter” indicates a major axis length. In some example embodiments, the average particle size may be measured by one or more suitable methods described above, for example, through a particle size analyzer.

In some example embodiments, thickness may be measured using an scanning electron microscope (SEM) or transmission electron microscope (TEM) image of a cross-section, but the present disclosure is not limited thereto and thickness may be measured using any suitable method that may measure thickness in the relevant field. The thickness may be an average thickness.

As used herein, soft carbon refers to a graphitizable carbon material that may be graphitized by heat treatment at high temperatures, for example at 2800° C., and hard carbon refers to non-graphitizable carbon material that may be not graphitized by heat treatment, or substantially is not graphitized at all (substantially resistant to graphitization). Hard carbon may also be referred to as a non- graphitizable carbon material. These terms, soft carbon and hard carbon, are well known tin the art.

In some example embodiments, crystalline carbon and amorphous carbon may be classified by X-ray diffraction analysis. The crystalline carbon includes natural graphite and artificial graphite. The natural graphite refers to naturally occurring graphite obtained by separation from minerals, and having, upon X-ray diffraction analysis, d002 of about 3.350 Å to about 3.360 Å. The artificial graphite refers to graphite made by graphitization and having, upon X-ray diffraction analysis, d002 of about 3.355 Å to about 3.365 Å. The amorphous carbon has a d002 of less than or equal to about 3.34 A if (e.g., when) analyzed by X-ray diffraction. The X-ray diffraction analysis (XRD) utilizes CuKα ray as a target line and utilizes an X-ray diffraction analyzer, for example, X′Pert (manufacturer: Malvern Panalytical), and to improve peak intensity resolution, the monochromator equipment may be removed and measured. The X-ray diffraction analysis may be performed using CuKα rays as target lines, wavelength λ=1.5418±0.02 Å, scan 2θ=20° to 80°, and scan rate of 1° /min to 5° /min.

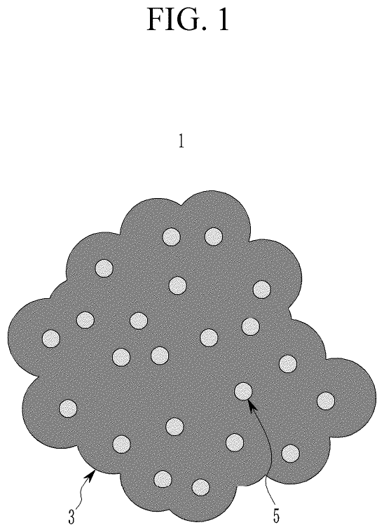

The negative electrode active material according to some example embodiments includes a crystalline carbon matrix having a BET specific surface area of less than or equal to about 8 m²/g and a graphitization degree of greater than or equal to about 95%; and silicon dispersed in the crystalline carbon matrix. FIG. 1 schematically shows a negative electrode active material 1 according to some example embodiments, which includes a crystalline carbon matrix 3 and silicon 5 dispersed in the crystalline carbon matrix 3.

The BET specific surface area of the negative electrode active material according to some example embodiments may be less than or equal to about 8 m²/g, about 0.5 m²/g to about 8 m²/g, or about 1 m²/g to about 5 m²/g.

If the BET specific surface area of the negative electrode active material is less than or equal to about 8 m²/g, the reaction area with the electrolyte is minimized or reduced, and thus there is less irreversible reaction during charging/discharging, which may be advantageous in terms of cycle-life characteristics.

In some example embodiments, the BET specific surface area may be the specific surface area obtained from the adsorption isotherm using the BET (Brunauer, Emmet, Teller) method. In the measurement of the adsorption isotherm, nitrogen gas may be utilized as the adsorption gas.

The crystalline carbon matrix according to some example embodiments may have a graphitization degree of greater than or equal to about 95%, about 95% to about 99%, about 95% to about 98%, or about 97% to about 99%.

In some example embodiments, the graphitization degree may be obtained by X-ray diffraction measurements. For example, the graphitization degree may be obtained by using an X-ray diffraction analyzer (e.g., Bruker D8 DISCOVER), measuring d002 according to the Japanese Industrial Standard (JIS) K 0131-1996 or JB/T 4220-2011 standards, and then calculating by (0.344-d₀₀₂)/(0.344−0.3354)×100%. Here, d₀₀₂ is a layer spacing of the graphite crystal structure expressed in nanometers (nm). X-ray diffraction analysis may be performed using CuKα rays as target lines, wavelength λ=1.5418±0.02 Å, scan 2θ=20° to 80°, and scan rate of 1° /min to 5° /min.

In the negative electrode active material according to some example embodiments, the crystalline carbon matrix has a high graphitization degree of greater than or equal to about 95%, and thus high or improved capacity/high density may be realized and a high or improved energy density negative electrode may be manufactured.

The crystalline carbon matrix according to some example embodiments may be porous. If the crystalline carbon matrix is porous, the porous matrix may be to absorb the volume expansion of silicon that may occur during charging and discharging, thereby preventing or reducing the overall volume of the negative electrode active material from increasing. For example, because the crystalline carbon matrix includes pores, these pores may act as a buffer to absorb volume expansion, so that if volume expansion of silicon dispersed in the crystalline carbon matrix occurs, the expanded volume may be absorbed. As a result, the structure of the negative electrode active material may be well maintained during charging and discharging, and cycle-life characteristics may be further improved.

Additionally, if the crystalline carbon matrix is porous, higher or improved efficiency and charging rate may be achieved.

In some example embodiments, the porosity of the crystalline carbon matrix may be from about 1% to about 50%, about 1% to about 30%, or about 1% to about 10%. If the porosity of the crystalline carbon matrix is within any of the above ranges, the volume expansion of silicon may be more effectively and sufficiently (or suitably) absorbed, thereby further improving cycle-life characteristics.

In some example embodiments, the porosity may be measured using a general porosity measurement method. For example, it may be measured by mercury intrusion porosimetry. In one or more embodiments, the porosity may be measured by the Barret-Joyner-Halenda (BJH) method through N₂ absorption isotherm. For example, the crystalline carbon matrix is heated to 523 K (Kelvin, absolute temperature) at a rate of about 10 K/min, then pretreated by maintaining it at this temperature and a pressure of less than or equal to about 100 mmHg for about 2 hours to about 10 hours, then in liquid nitrogen whose relative pressure (P/P0) is adjusted to less than or equal to about 0.01 torr, nitrogen is adsorbed at about 32 points from about 0.01 torr to about 0.955 torr, and then nitrogen is desorbed at about 24 points until the relative pressure is about 0.14 torr. For a volume of crystalline carbon matrix, porosity may be obtained from the N₂ content (e.g., amount) measured by the above method.

In some example embodiments, the crystalline carbon may be artificial graphite, and may be unspecified (randomly)-shaped, plate-shaped, flake-shaped, spherical, and/or fibrous artificial graphite.

In some example embodiments, the silicon is dispersed within the crystalline carbon matrix to be included in the negative electrode active material, and e.g., the silicon is dispersed within the crystalline carbon matrix to be included in the negative electrode active material. Because silicon is dispersed within the crystalline carbon matrix and is not exposed to the outside, side reactions due to contact between silicon and electrolyte may be suppressed or reduced.

In addition, because the crystalline carbon matrix may suppress or reduce the volume expansion of silicon during charging and discharging, the high improved capacity characteristics of silicon may be effectively or suitably utilized.

The silicon may be nano silicon, for example, nano silicon particles. An average size (e.g., average particle size or average particle diameter) of the nano silicon may be less than or equal to about 50 nm, about 1 nm to about 40 nm, about 1 nm to about 30 nm, about 1 nm to about 20 nm, or about 2 nm to about 15 nm. If the silicon is nano silicon, in some example embodiments, nano silicon having the above size may have an advantage in cycle-life characteristics due to small (or insubstantial) volume expansion during charging/discharging of a lithium-ion battery.

In some example embodiments, an amount of the silicon may be about 1 wt % to about 55 wt %, about 5 wt % to about 55 wt %, about 10 wt % to about 55 wt %, or about 27 wt % to about 55 wt % based on 100 wt % of the negative electrode active material. If the silicon content (e.g., amount) is within any of the above ranges, higher capacity may be achieved.

In some example embodiments, the silicon may be pure silicon. However, silicon may be naturally oxidized and may exist in trace amounts in the negative electrode active material in the form of silicon oxide. Accordingly, the negative electrode active material according to some example embodiments may further include a trace amount of oxygen. An amount of oxygen may be about 0.5 wt % to about 20 wt %, about 0.5 wt % to about 10 wt %, or about 0.5 wt % to about 1 wt % based on 100 wt % of the negative electrode active material. If the amount of oxygen is in a trace amount within any of the above ranges, higher battery efficiency may be realized because the initial efficiency is suitably high, the irreversible capacity is very small (e.g., there are very few irreversible reactions during charging/discharging), side reactions may be further reduced, and cycle-life characteristics may be further improved. In other words, if the oxygen content is within the specified ranges, the initial efficiency of the battery is high, and the irreversible capacity is very small, meaning there are very few irreversible reactions during charging and discharging.

In some example embodiments, the oxygen content (e.g., amount) may be measured by infrared absorption using an oxygen analyzer, and measurement conditions may be appropriately or suitably adjusted within conditions suitable in the art.

The negative electrode active material according to some example embodiments may have the advantage of reducing side reactions with the electrolyte by supporting silicon inside, rather than outside, a crystalline carbon matrix, for example, a porous crystalline carbon matrix, and may have the high capacity advantages of both (e.g., simultaneously) silicon and graphite due to its high crystallinity (e.g., due to the overall high crystallinity of the negative electrode active material). For example, the negative electrode active material in some embodiments may reduce or minimize side reactions with the electrolyte by incorporating silicon within a porous crystalline carbon matrix. This design leverages the high capacity benefits of both graphite and silicon, due to the material's high overall crystallinity.

In some example embodiments, the negative electrode active material may further include hard carbon and/or soft carbon. If hard carbon and/or soft carbon is further included, rapid charging may be further improved.

If hard carbon and/or soft carbon is further included, an amount of hard carbon and/or soft carbon may be greater than about 0 wt % and less than or equal to about 30 wt %, about 2 wt % to about 20 wt %, or about 2 wt % to about 10 wt % based on 100 wt % of the negative electrode active material.

In the negative electrode active material according to some example embodiments, an amount of the crystalline carbon matrix may be a balance amount (e.g., amount remaining after) excluding the amounts of silicon, optionally oxygen, and hard carbon.

A pellet density of the negative electrode active material according to some example embodiments may be greater than or equal to about 1.7 g/cc, about 1.7 g/cc to about 2.0 g/cc, or about 1.7 g/cc to about 1.9 g/cc. The fact that the pellet density of the negative electrode active material is greater than or equal to about 1.7 g/cc indicates that the negative electrode active material is soft, for example, meaning that it may be relatively easily pressed. If the pellet density of the negative electrode active material according to some example embodiments is greater than or equal to about 1.7 g/cc, a suitably high-density negative electrode may be manufactured, and a suitably high energy density negative electrode may be implemented. Additionally, the negative electrode active material according to some example embodiments has a pellet density of greater than or equal to about 1.7 g/cc, may exhibit (have) excellent or improved charging rate(s).

In some example embodiments, the pellet density may be measured by a suitable method in the art, for example, it may be obtained by measuring under a certain pressure, for example, 2-ton pressure, using a pellet density machine.

In some example embodiments, the pellet density may be a powder pellet density or a slurry pellet density. The powder pellet density is a density measured by manufacturing pellets using only the negative electrode active material. The powder pellet manufacturing process may be performed by putting about 0.5 g to about 1.0 g of the negative electrode active material into a mold and maintaining it for about 20 seconds to about 30 seconds under a pressure of about 1.0 tons to about 2.0 tons.

The slurry pellet density is a density measured using pellets prepared by mixing a negative electrode active material, a binder, and optionally a conductive material to prepare a slurry, drying and pulverizing this slurry, and then applying pressure. The process of applying the pressure may be performed by maintaining the pressure for about 20 seconds to about 30 seconds under a pressure of about 1.0 ton to about 6.0 tons.

The average particle diameter (D50) of the negative electrode active material according to some example embodiments may be about 5 μm to about 15 μm.

### Method of Preparing a Negative Electrode Active Material

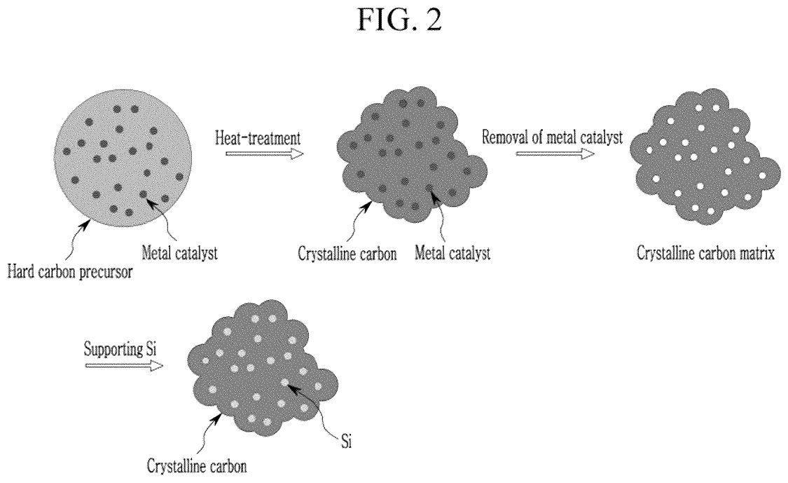

The negative electrode active material according to some example embodiments is prepared by mixing a carbon precursor and a metal catalyst to prepare a mixture, heat-treating the mixture to produce a heat-treated product, removing the metal catalyst from the heat-treated product to produce a crystalline carbon matrix, and supporting silicon on the crystalline carbon matrix (e.g., dispersing or inserting silicon in the crystalline carbon matrix). Hereinafter, each process will be described with reference to FIG. 2.

A carbon precursor and a metal catalyst are mixed to prepare a mixture. The metal catalyst plays a role of promoting graphitization of the carbon precursor and/or facilitating the graphitization. Because some example embodiments heat- treats the carbon precursor with the metal catalyst together, an amorphous carbon precursor, which is impossible to graphitize even though heat-treated at a high temperature, e.g., a hard carbon precursor, may be possible to graphitize. A soft carbon precursor, if it be heat-treated at a high temperature of greater than or equal to about 3000° C. to graphitize, may be graphitized, even though heat-treated at a low temperature. In other words, because some example embodiments heat-treat the carbon precursor with the metal catalyst together, an amorphous carbon precursor, which cannot be graphitized even if heat-treated at a high temperature (e.g., a hard carbon precursor), can be graphitized (e.g., can caused the carbon atoms to rearrange into a crystalline structure typical of graphite). Additionally, a soft carbon precursor, which typically requires heat treatment at a temperature greater than or equal to about 3000° C. to graphitize, may be graphitized at a lower temperature.

In related art, because a hard carbon precursor, if heat-treated, is formed into hard carbon, this hard carbon, even if heat-treated at a high temperature, is not graphitized. However, because some example embodiments utilize the metal catalyst, if the hard carbon precursor is heat-treated, the hard carbon precursor is graphitized, forming crystalline carbon, for example, graphite. The graphite prepared through this process may be artificial graphite.

A crystalline carbon matrix prepared through the process may be a porous crystalline carbon matrix, for example, a crystalline carbon matrix having pores. Because the pores are spaces where silicon is positioned-the silicon-supporting process-the silicon may be distributed in the crystalline carbon matrix.

The carbon precursor and the metal catalyst may be mixed in a weight ratio of about 95:5 to about 50:50, about 95:5 to about 60:40, or about 90:10 to about 70:30. If the mixing ratio of the carbon precursor and the metal catalyst is included within any of these ranges, the carbon precursor may be sufficiently or suitably and easily graphitized.

The metal catalyst may be Fe, Ni, Al, Mg, and/or a (e.g., any suitable) combination thereof. The metal catalyst may have an average size (e.g., average particle size or average particle diameter) of about 5 nm to about 200 nm, about 5 nm to about 100 nm, or about 10 nm to about 50 nm. If the metal catalyst has a nanometer size, the pores formed in a process of removing the metal catalyst may have a nanometer size. The silicon positioned in the pores may have a nanometer size.

If the metal catalyst has an average size within any of these ranges, the silicon may be sufficiently or suitably supported on the pores formed by this metal catalyst, thus obtaining suitably high or improved capacity.

The carbon precursor may be biomass, resin, and/or pitch, e.g., lignin, a polyimide resin, a furan resin, a phenol resin, a polyvinyl alcohol resin, a poly(meth)acrylic acid resin, a polyurethane resin, a cellulose resin, an epoxy resin, a polystyrene resin, petroleum pitch, coal pitch, mesophase pitch, and/or a (e.g., any suitable) combination thereof.

The mixture may be heat-treated to prepare a heat-treated product. The heat treatment process may be performed at about 1300° C. to about 2000° C. or about 1300° C. to about 1800° C. The heat treatment process may be performed under an inert atmosphere, wherein the inert atmosphere may be N₂, helium, argon, and/or a (e.g., any suitable) combination thereof.

In the heat treatment process, the carbon precursor is converted into crystalline carbon, e.g., graphite, under the influence of the catalyst, thus preparing the heat-treated product including the crystalline carbon and the metal catalyst. In this heat treatment process, a portion of the carbon precursor may be present as hard carbon and/or soft carbon.

Subsequently, the metal catalyst is removed from the heat-treated product to prepare a crystalline carbon matrix. Through the metal catalyst removal process, the pores are formed in the crystalline carbon matrix, thus preparing the porous crystalline carbon matrix.

The metal catalyst removal process may be performed by using acid. The acid may be hydrochloric acid, nitric acid, sulfuric acid, and/or a (e.g., any suitable) combination thereof. The metal catalyst removal process by using the acid may be performed by dipping the heat-treated product in the acid.

A negative electrode active material is prepared by supporting (e.g., positioning) the silicon in the crystalline carbon matrix. According to this process, the silicon may be supported in the crystalline carbon matrix, e.g., may be positioned in the pores inside the crystalline carbon matrix, thereby preparing the negative electrode active material including the silicon distributed in the crystalline carbon matrix.

The process of supporting the silicon may be performed by using silane gas and/or a silane compound. A process of using the silane gas may be performed in a chemical vapor deposition (CVD) method.

The silane compound may include Si, H, SiH₄, and/or a (e.g., any suitable) combination thereof. A process of using the silane compound may be performed in the chemical vapor deposition (CVD) method. The chemical vapor deposition (CVD) method may be performed under appropriate or suitable conditions, for example, for appropriate or suitable time, so that the silicon may have an amount (e.g., content) of 1 wt % to 55 wt % in the final active material.

The prepared negative electrode active material may include the portion of the hard carbon and/or soft carbon formed during the heat treatment process.

### Rechargeable Lithium Battery

Some example embodiments provide a rechargeable lithium battery including a negative electrode including the negative electrode active material, a positive electrode, and an electrolyte.

### Negative Electrode

The negative electrode includes a current collector and a negative electrode active material layer formed on the current collector and including the negative electrode active material. The negative electrode active material layer may include a binder and may further include a conductive material.

For example, the negative electrode active material layer may include about 90 wt % to about 99 wt % of the negative electrode active material and about 1 wt % to about 10 wt % of the binder, and may also include about 90 wt % to about 99 wt % of the negative electrode active material, about 0.5 wt % to about 5 wt % of the binder, and about 0.5 wt % to about 5 wt % of a conductive material.

The binder serves to adhere the negative electrode active material particles to each other and also helps the negative electrode active material to adhere to the current collector. The binder may be a non-aqueous binder, an aqueous binder, a dry binder, and/or a (e.g., any suitable) combination thereof.

The non-aqueous binder may be polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, and/or a (e.g., any suitable) combination thereof.

The aqueous binder may be a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinyl pyrrolidone, polyepichlorohydrine, polyphosphazene, poly(meth)acrylonitrile, an ethylene propylene diene copolymer, polyvinylpyridine, chlorosulfonated polyethylene, latex, a polyester resin, (meth)acrylic resin, a phenol resin, an epoxy resin, polyvinyl alcohol, and/or a (e.g., any suitable) combination thereof.

The aqueous binder may be a cellulose-based compound, and the cellulose-based compound may be utilized together with the aqueous binder described above. The cellulose-based compound may impart viscosity, and thus it may be a thickener, and it may also be a binder because it can act as a binder. Accordingly, an amount of the cellulose-based compound may be appropriately or suitably adjusted within the binder content (e.g., amount). As the cellulose-based compound, one or more of carboxymethyl cellulose, hydroxypropylmethyl cellulose, methyl cellulose, or alkali metal salts thereof may be mixed and utilized. The alkali metal may be Na, K, and/or Li.

The dry binder may be a polymer material capable of being fibrous, and may be, for example, polytetrafluoroethylene, polyvinylidene fluoride, polyvinylidene fluoride-hexafluoropropylene copolymer, polyethylene oxide, and/or a (e.g., any suitable) combination thereof.

The conductive material (e.g., electron conductor) is utilized to impart conductivity to the electrode, and any suitable electrically conductive material may be utilized as a conductive material unless it causes an undesirable chemical change in a battery. Examples of the conductive material may include a carbon-based material such as natural graphite, artificial graphite, carbon black, acetylene black, ketjen black, carbon fiber, carbon nanofibers, carbon nanotubes, and/or the like; a metal-based material including copper, nickel, aluminum, silver, and/or the like, in the form of metal powders and/or metal fibers; a conductive polymer such as a polyphenylene derivative; and/or a (e.g., any suitable) mixture thereof.

The negative electrode current collector may include a copper foil, a nickel foil, a stainless steel foil, a titanium foil, a nickel foam, a copper foam, a polymer substrate coated with a conductive metal, and/or a (e.g., any suitable) combination thereof.

### Positive Electrode

The positive electrode for a rechargeable lithium battery may include a current collector and a positive electrode active material layer on the current collector. The positive electrode active material layer may include a positive electrode active material and may further include a binder and/or a conductive material.

For example, the positive electrode may further include an additive that may function as a sacrificial positive electrode.

An amount of the positive electrode active material may be about 90 wt % to about 99.5 wt %, and amount of the binder or the conductive material may be about 0.5 wt % to about 5 wt % based on 100 wt % of the positive electrode active material layer. In another embodiments, an amount of the positive electrode active material may be about 90 wt % to about 99 wt %, and each amount of the binder and the conductive material may be about 0.5 wt % to about 5 wt % based on 100 wt % of the positive electrode active material layer.

The positive electrode active material may be a compound (lithiated intercalation compound) capable of intercalating and deintercalating lithium. For example, one or more types (kinds) of composite oxides of lithium and a metal selected from among cobalt, manganese, nickel, and/or one or more (e.g., any suitable) combinations thereof may be utilized.

The composite oxide may be a lithium transition metal composite oxide, and non-limiting examples may include a lithium nickel-based oxide, a lithium cobalt-based oxide, a lithium manganese-based oxide, a lithium iron phosphate-based compound, a cobalt-free lithium nickel-manganese-based oxide, and/or a (e.g., any suitable) combination thereof.

As an example, a compound represented by any of (e.g., selected from among) the following chemical formulae may be utilized: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0=c≤0.5, 0<α<2); LiₐNi_{1-b-c}Mn_{b}X_{c}O_{2-α}D_{α} (0.90≤a≤1.8, 0≤b≤0.5, 0≤c≤0.5, 0< <2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}GbO₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulae, A is Ni, Co, Mn, and/or a (e.g., any suitable) combination thereof; X is Al, Ni, Co, Mn, Cr, Fe, Mg, Sr, V, a rare earth element, and/or a (e.g., any suitable) combination thereof; D is O, F, S, P, and/or a (e.g., any suitable) combination thereof; G is Al, Cr, Mn, Fe, Mg, La, Ce, Sr, V, and/or a (e.g., any suitable) combination thereof; and L¹ is Mn, Al, and/or a (e.g., any suitable) combination thereof.

For example, the positive electrode active material may be may be a high nickel-based positive electrode active material having a nickel content (e.g., amount) of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may realize suitably high capacity and may be applied to a high-capacity, high-density rechargeable lithium battery.

The binder serves to attach the positive electrode active material particles well or suitably to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinyl fluoride, an ethylene oxide-including polymer, polyvinyl pyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like, but are not limited thereto.

The conductive material may be utilized to impart conductivity (e.g., electrical conductivity) to the electrode. Any suitable material that does not cause chemical change (e.g., does not cause an undesirable chemical change in the rechargeable lithium battery) and suitably conducts electrons may be utilized in the battery. Examples of the conductive material may include a carbon-based material such as natural graphite, artificial graphite, carbon black, acetylene black, ketjen black, a carbon fiber, a carbon nanofiber, and carbon nanotube; a metal-based material including copper, nickel, aluminum, silver, and/or the like, in a form of a metal powder and/or a metal fiber; a conductive polymer such as a polyphenylene derivative; and/or a (e.g., any suitable) mixture thereof.

The current collector may include Al, but the present disclosure is not limited thereto.

### Electrolyte

The electrolyte includes a non-aqueous organic solvent and a lithium salt.

The non-aqueous organic solvent serves as a medium for transmitting ions taking part in the electrochemical reaction of a battery.

The non-aqueous organic solvent may be a carbonate-based solvent, an ester-based solvent, an ether-based solvent, a ketone-based solvent, an alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethylacetate, methylpropionate, ethylpropionate, decanolide, mevalonolactone, valerolactone, v-butyrolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone. The alcohol-based solvent may include ethyl alcohol, isopropyl alcohol, and/or the like, and the aprotic solvent may include nitriles such as R-CN (wherein R is a C2 to C20 linear, branched, or cyclic hydrocarbon group, or may include a double bond, an aromatic ring, or an ether group), amides such as dimethylformamide, dioxolanes such as 1,3-dioxolane and/or 1,4-dioxolane, sulfolanes, and/or the like.

The non-aqueous organic solvent may be utilized alone or in combination of two or more.

Additionally, if using a carbonate-based solvent, cyclic carbonate and chain (e.g., linear) carbonate may be mixed and utilized, and cyclic carbonate and chain carbonate may be mixed at a volume ratio of about 1:1 to about 1:9.

The lithium salt dissolved in the organic solvent supplies lithium ions in a battery, enables or facilitates a basic operation of a rechargeable lithium battery, and improves transportation of the lithium ions between positive and negative electrodes. Examples of a lithium salt may include one or more than one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂) (C_{y}F_{2y+1}SO₂) (where x and y are integers from 1 to 20), lithium trifluoromethane sulfonate, lithium tetrafluoroethanesulfonate, lithium difluorobis(oxalato)phosphate, (LiDFOP), and lithium bis(oxalato)borate (LiBOB).

### Separator

The rechargeable lithium battery may further include a separator between the negative electrode and the positive electrode, depending on a type (kind) of the battery. Examples of a suitable separator material include polyethylene, polypropylene, polyvinylidene fluoride, and multi-layers thereof such as a polyethylene/polypropylene double-layered separator, a polyethylene/polypropylene/polyethylene triple-layered separator, and/or a polypropylene/polyethylene/polypropylene triple-layered separator.

The separator may include a porous substrate and a coating layer including an organic material, an inorganic material, and/or a (e.g., any suitable) combination thereof on one or both (e.g., simultaneously) surfaces (e.g., opposite surfaces) of the porous substrate.

The porous substrate may be a polymer film formed of any one selected from among polymers of polyolefin such as polyethylene and/or polypropylene, polyester such as polyethylene terephthalate and/or polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, and polytetrafluoroethylene (TEFLON™), or a copolymer or mixture of two or more thereof.

The organic material may include a polyvinylidene fluoride-based polymer and/or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but the present disclosure is not limited thereto.

The organic material and the inorganic material may be mixed in one coating layer, or a coating layer including an organic material and a coating layer including an inorganic material may be stacked.

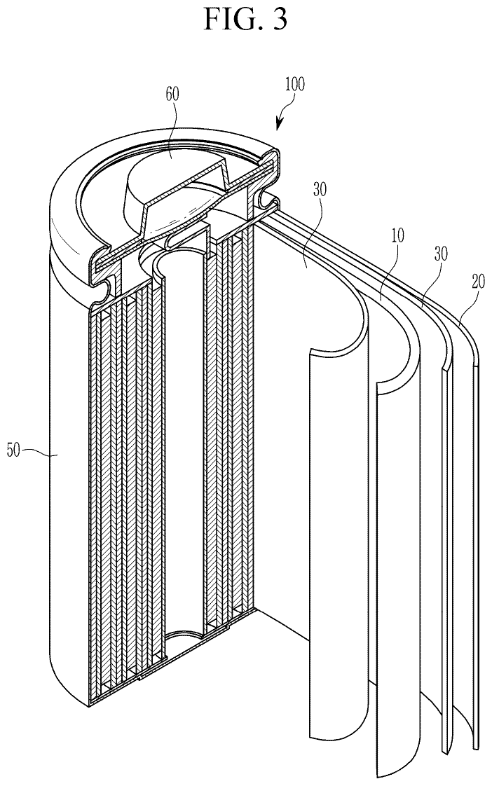

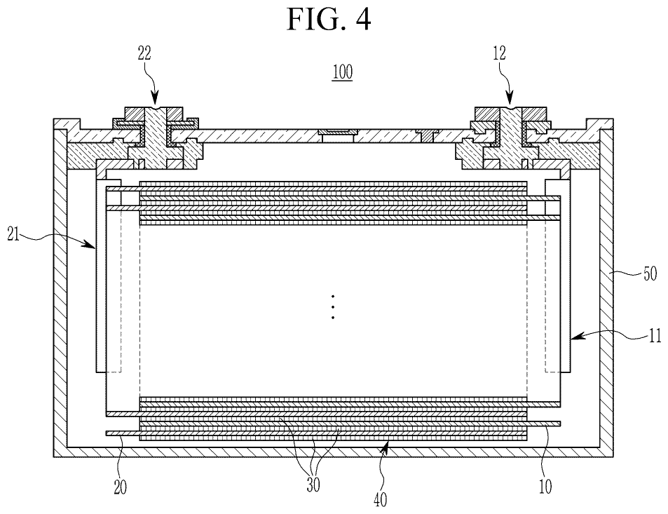

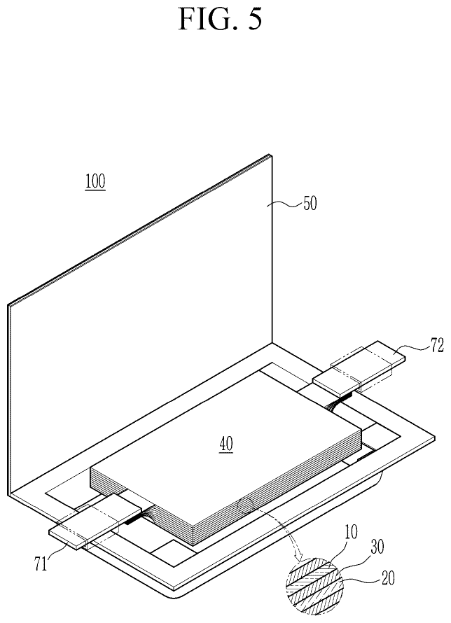

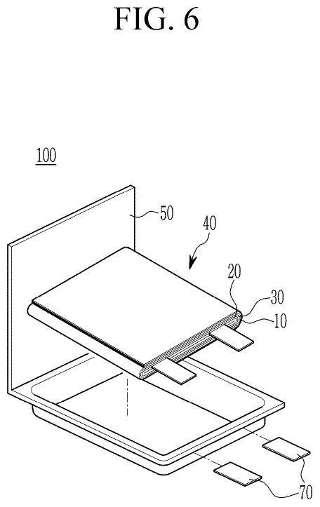

The rechargeable lithium battery may be classified into cylindrical, prismatic, pouch, and/or coin-type (kind) battery, and/or the like depending on its shape. FIGS. 3 to 6 are schematic views illustrating rechargeable lithium batteries according to some example embodiments. FIG. 3 shows a cylindrical battery, FIG. 4 shows a prismatic battery, and FIGS. 5 and 6 show pouch-type (kind) batteries. Referring to FIGS. 3 to 6, the rechargeable lithium battery 100 may include an electrode assembly 40 including a separator 30 between a positive electrode 10 and a negative electrode 20, and a case 50 in which the electrode assembly 40 is housed. The positive electrode 10, the negative electrode 20, and the separator 30 may be impregnated with an electrolyte. The rechargeable lithium battery 100 may include a sealing member 60 sealing the case 50 as shown in FIG. 3. In addition, in FIG. 4, the rechargeable lithium battery 100 may include a positive lead tab 11, a positive terminal 12, a negative lead tab 21, and a negative terminal 22. As shown in FIGS. 5 and 6, the rechargeable lithium battery 100 includes an electrode tab 70, that includes a positive electrode tab 71 and a negative electrode tab 72 serving as an electrical path for inducing the current formed in the electrode assembly 40 to the outside.

The rechargeable lithium battery according to some example embodiments may be applied to automobiles, mobile phones, and/or one or more suitable types (kinds) of electrical devices, but the present disclosure is not limited thereto.

Hereinafter, examples of the present disclosure and comparative examples are described. These examples, however, are not in any sense to be interpreted as limiting the scope of the present disclosure.

### Example 1

Lignin and Fe (an average size (D50): 100 nm) were mixed in a weight ratio of 80:20 to prepare a mixture.

The mixture was heat-treated at 1500° C. under a N₂ atmosphere to prepare a heat-treated product including Fe and artificial graphite.

The heat-treated product was dipped in hydrochloric acid to prepare a porous artificial graphite matrix from which the Fe was removed. In the porous graphite matrix, pores had an average size (e.g., average diameter-here, the diameter may also refer to the major axis length of the pores) of 80 nm and porosity of 16%. The porous graphite matrix had a BET specific surface area of 6 m²/g, which was obtained from an adsorption isotherm by a BET (Brunauer, Emmet, Teller) method, and had a graphitization degree of 95%, which was obtained by measuring d002 according to JIS K 0131-1996 with an X-ray diffraction analyzer (Bruker D8 Discover) to calculate (0.344-d₀₀₂)/(0.344−0.3354)×100%.

Silicon was supported (e.g., inserted) into the prepared porous artificial graphite matrix by using a chemical vapor deposition (CVD) method (10 hours). Through this process, a negative electrode active material in which the silicon was distributed inside the porous artificial graphite matrix was prepared. An amount of the silicon in the prepared negative electrode active material was 30 wt % based on 100 wt % of the negative electrode active material. The prepared negative electrode active material had an average particle diameter (D50) of 10 μm, which was analyzed by a particle size analyzer.

98 wt % of the negative electrode active material, 1 wt % of carboxymethyl cellulose, and 1 wt % of a styrene butadiene rubber were mixed in a water solvent to prepare a negative electrode active material layer slurry.

The negative electrode active material layer slurry was coated on a Cu foil current collector and then, dried and compressed to manufacture a negative electrode.

The negative electrode, a lithium metal counter electrode, and an electrolyte were utilized to fabricate a half-cell. The electrolyte was prepared by mixing ethylene carbonate, dimethyl carbonate, and ethylmethyl carbonate (in a volume ratio of 30:40:30) and dissolving 1 M LiPF₆ in the mixed solvent.

In other words, lignin and iron (Fe) particles, averaging 100 nm in size, were mixed in an 80:20 weight ratio. This mixture was heat-treated at 1500° C. in a nitrogen atmosphere, resulting in a product containing Fe and artificial graphite. The product was then treated with hydrochloric acid to remove the Fe, creating a porous artificial graphite matrix with pores averaging 80 nm in diameter and a porosity of 16%. This matrix had a BET specific surface area of 6 m²/g and a graphitization degree of 95%. Silicon was then incorporated into the porous matrix using chemical vapor deposition (CVD), resulting in a negative electrode active material with 30 wt % silicon and an average particle diameter of 10 μm. This material was mixed with carboxymethyl cellulose and styrene butadiene rubber to form a slurry, which was coated onto a copper foil, dried, and compressed to create a negative electrode. This electrode, along with a lithium metal counter electrode and an electrolyte, was used to fabricate a half-cell. The electrolyte was a mixture of ethylene carbonate, dimethyl carbonate, and ethylmethyl carbonate with 1 M LiPF₆.

### Example 2

A negative electrode active material (an average particle diameter (D50): 10 μm) and a half-cell were manufactured in substantially the same manner as in Example 1 except that a porous artificial graphite matrix having a BET specific surface area of 5 m²/g and a graphitization degree of 95% was manufactured by using Fe with an average size (D50) of 50 nm.

### Example 3

A negative electrode active material (an average particle diameter (D50): 10 μm) and a half-cell were manufactured in substantially the same manner as in Example 1 except that a porous artificial graphite matrix having a BET specific surface area of 1 m²/g and a graphitization degree of 95% was manufactured by using Fe with an average size (D50) of 10 nm.

### Example 4

A negative electrode active material (an average particle diameter (D50): 10 μm) and a half-cell were manufactured in substantially the same manner as in Example 1 except that a porous artificial graphite matrix having a BET specific surface area of 1.5 m²/g and a graphitization degree of 99% was manufactured by using Fe with an average size (D50) of 20 nm and changing the heat treatment temperature to 1600° C.

### Example 5

Petroleum pitch and Fe (an average size (D50): 80 nm) were mixed in a weight ratio of 70:30 to prepare a mixture.

The mixture was heat-treated at 1500° C. under a N₂ atmosphere to prepare a heat-treated product including Fe and artificial graphite.

The heat-treated product was dipped in hydrochloric acid to prepare a porous artificial graphite matrix from which Fe was removed. In the porous artificial graphite matrix, pores had an average size of 43 nm and porosity of 3%. The porosity was measured through N₂ absorption isotherm in a BJH (Barret-Joyner-Halenda) method. The porous artificial graphite matrix had a BET specific surface area of 4.5 m²/g, which was obtained from an adsorption isotherm by the BET (Brunauer, Emmet, Teller) method, and a graphitization degree of 96%, which was obtained as (0.344-d₀₀₂)/(0.344−0.3354)×100% by using an X-ray diffraction analyzer (Bruker D8 Discover) to measure d002 according to JIS K 0131-1996.

Silicon was supported into the prepared porous artificial graphite matrix by using a CVD (chemical vapor deposition) method. Through this process, a negative electrode active material, in which the silicon was distributed inside the porous artificial graphite matrix, was prepared. The prepared negative electrode active material had a silicon content (e.g., amount) of 32 wt % based on 100 wt % of the negative electrode active material. The negative electrode active material had an average particle diameter (D50) of 10 μm, which was measured by a particle size analyzer.

98 wt % of the negative electrode active material, 1 wt % of carboxymethyl cellulose, and 1 wt % of a styrene butadiene rubber were mixed in a water solvent to prepare a negative electrode active material layer slurry.

The negative electrode active material layer slurry was coated on a Cu foil current collector and then, dried and compressed to manufacture a negative electrode.

The negative electrode, a lithium metal counter electrode, and an electrolyte was utilized to fabricate a half-cell. The electrolyte was prepared by mixing ethylene carbonate, dimethyl carbonate, and ethylmethyl carbonate (in a volume ratio of 30:40:30) and dissolving 1 M LiPF₆ in the mixed solvent.

### Comparative Example 1

A negative electrode active material (an average particle diameter (D50): 10 μm) and a half-cell were manufactured in substantially the same manner as in Example 1 except that a porous artificial graphite matrix having a BET specific surface area of 9 m²/g and a graphitization degree of 95% was prepared by using Fe with an average size (D50) of 250 nm and reducing the CVD time (8 hours), and the silicon content (e.g., amount) was reduced to 26 wt % based on 100 wt % of the negative electrode active material.

### Comparative Example 2

A negative electrode active material (an average particle diameter (D50): 10 μm) and a half-cell were manufactured in substantially the same manner as in Example 1 except that a porous artificial graphite matrix having a BET specific surface area of 8 m²/g and a graphitization degree of 94% was prepared by changing the heat treatment temperature to 1200° C.

### Comparative Example 3

A negative electrode active material (an average particle diameter (D50): 10 μm) and a half-cell were manufactured in substantially the same manner as in Example 1 except that a porous artificial graphite matrix having a BET specific surface area of 0.45 m²/g and a graphitization degree of 94% was prepared by using Fe with an average size (D50) of 3 nm, and the silicon content (e.g., amount) was reduced to 10 wt % based on 100 wt % of the negative electrode active material.

### Experimental Example 1) Evaluation of Pellet Density

1 g of each negative electrode active material according to Examples 1 to 5 and Comparative Examples 1 to 3, respectively, was placed in a mold and then, maintained under a pressure of 1.5 tons for 20 seconds to manufacture a pellet.

The pellet was measured with respect to density. The results are shown in Table 1.

### Experimental Example 2) Evaluation of Cycle-life

The half-cells according to Examples 1 to 5 and Comparative Examples 1 to 3 were respectively 500 cycles charged and discharged at 0.5 C. A ratio of 500^{th} discharge capacity to the 1^{st} discharge capacity was calculated. The results are shown as capacity retention in Table 1.

### Experimental Example 3) Evaluation of High Rate Capability

The half-cells according to Examples 1 to 5 and Comparative Examples 1 to 3 were charged and discharged once at 0.1 C and once at 2 C. A ratio of 2 C discharge capacity to 0.1 C discharge capacity was calculated. The results are shown as high rate capability in Table 1.

TABLE 1

| | Pellet | Capacity | High rate |
|---|---|---|---|
| | density | retention | capability |
| | (g/cc) | (%) | (%) |
| Example 1 | 1.75 | 81 | 54 |
| Example 2 | 1.71 | 83 | 58 |
| Example 3 | 1.74 | 87 | 54 |
| Example 4 | 1.83 | 87 | 55 |
| Example 5 | 1.81 | 88 | 50 |
| Comparative Example 1 | 1.65 | 81 | 47 |
| Comparative Example 2 | 1.49 | 77 | 49 |
| Comparative Example 3 | 1.55 | 73 | 47 |

As shown in Table 1, the cells including a porous artificial graphite matrix having a BET specific surface area of less than or equal to 8 m²/g and a graphitization degree of greater than or equal to 95% according to Examples 1 to 5 all satisfied capacity retention of greater than or equal to 81% and high rate capability of greater than or equal to 50%.

In contrast, the cell of Comparative Example 1 including a porous artificial graphite matrix having a BET specific surface area of 9 m²/g exhibited high rate capability of less than 50%, which was less than the high rate capability of the Examples. In addition, the cells including a porous artificial graphite matrix having a graphitization degree of 94% according to Comparative Examples 2 and 3 exhibited capacity retention of less than 80% and high rate capability of less than 50%, that is, both showed reduced capacity retention and high rate capability as compared with the Examples.

In the context of the present disclosure and unless otherwise defined, the terms “use,” “using,” and “used” may be considered synonymous with the terms “utilize,” “utilizing,” and “utilized,” respectively.

As used herein, expressions such as “at least one of”, “one of”, and “selected from”, when preceding a list of elements, modify the entire list of elements and do not modify the individual elements of the list. For example, “at least one selected from among a, b and c”, “at least one of a, b or c”, and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A battery manufacturing device, a battery management system (BMS) device, and/or any other relevant devices or components according to embodiments of the present invention described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

While this disclosure has been described in connection with what is presently considered to be example embodiments, it is to be understood that the present disclosure is not limited to the disclosed embodiments, but, on the contrary, is intended to cover one or more suitable modifications and equivalent arrangements included within the spirit and scope of the appended claims and their equivalents.

What is claimed is:

1. A negative electrode active material, comprising:
a crystalline carbon matrix having a BET (Brunauer, Emmett, and Teller) specific surface area of less than or equal to about 8 m²/g and a graphitization degree of greater than or equal to about 95%; and
silicon dispersed in the crystalline carbon matrix.

2. The negative electrode active material as claimed in claim 1, wherein the BET specific surface area of the crystalline carbon matrix is about 0.5 m²/g to about 8 m²/g.

3. The negative electrode active material as claimed in claim 1, wherein the silicon is nano silicon.

4. The negative electrode active material as claimed in claim 3, wherein an average particle size of the nano silicon is less than or equal to about 50 nm.

5. The negative electrode active material as claimed in claim 4, wherein an average particle size of the nano silicon is about 1 nm to about 40 nm.

6. The negative electrode active material as claimed in claim 1, wherein an amount of silicon is about 1 wt % to about 55 wt % based on 100 wt % of the negative electrode active material.

7. The negative electrode active material as claimed in claim 1, wherein the graphitization degree of the crystalline carbon matrix is about 95% to about 98%.

8. The negative electrode active material as claimed in claim 1, wherein the crystalline carbon matrix is porous.

9. The negative electrode active material as claimed in claim 8, wherein the crystalline carbon matrix has porosity of about 1% to about 50%.

10. The negative electrode active material as claimed in claim 1, wherein the negative electrode active material further comprises oxygen in an amount of about 0.5 wt % to about 20 wt % based on 100 wt % of the negative electrode active material.

11. The negative electrode active material as claimed in claim 1, wherein a pellet density of the negative electrode active material is greater than or equal to about 1.7 g/cc.

12. A method, the method comprising:
mixing a carbon precursor and a metal catalyst to prepare a mixture;
heat-treating the mixture to produce a heat-treated product;
removing the metal catalyst from the heat-treated product to produce a crystalline carbon matrix; and
supporting silicon on the crystalline carbon matrix,
wherein the method is a method of preparing a negative electrode active material.

13. The method as claimed in claim 12, wherein the metal catalyst is Fe, Ni, Al, Mg, or a combination thereof.

14. The method as claimed in claim 12, wherein the carbon precursor is at least one of biomass, resin, or pitch.

15. The method as claimed in claim 12, wherein the heat-treating is performed at a temperature of about 1300° C. to about 2000° C.

16. The method as claimed in claim 12, wherein a mixing ratio of the carbon precursor and the metal catalyst is a weight ratio of about 95:5 to about 50:50.

17. The method as claimed in claim 12, wherein an average particle size of the metal catalyst is about 5 nm to about 200 nm.

18. The method as claimed in claim 12, wherein the removing of the metal catalyst is performed utilizing an acid.

19. The method as claimed in claim 12, wherein the supporting of silicon is performed utilizing silane gas or a silane compound.

20. A rechargeable lithium battery, comprising
a negative electrode comprising the negative electrode active material as claimed in claim 1;
a positive electrode; and
an electrolyte.
